(19) United States
(12) Patent Application Publication
(10) Pub. No.: US 2006/0035051 A1
(43) Pub. Date: Feb. 16, 2006

(54) Glazing

(76) Inventor: Jean-Benoit Lhoest, Jumet (BE)

Correspondence Address: Supervisor Patent Prosecution Services;Piper Rudnick, 1200 Nineteenth Street NW, Washington, DC, 20036-2412, US

(21) Appl. No.: 10/311,683

(22) PCT Filed: Jun. 21, 2001
(86) PCT No.: PCT/EP01/07061

§ 371 Date: Dec. 19, 2002

(30) Foreign Application Priority Data
Jun. 23, 2000 (EP) 00202194.7

(51) Int. Cl. G09F 3/00

(52) U.S. Cl. 428/43; 219/203

(57) ABSTRACT

A glazing panel (10) is assembled in a frame (15) by a fixing member (21) secured to a surface of one of the sheets of glass at an attachment portion of the glazing panel. The attachment portion of the glazing panel comprises a heatable fracturing element (23, 24) adapted to fracture at least a portion of the glazing panel to facilitate separation of at least a portion of the glazing from its fixing member (21). The glazing panel may be easily removed from its frame (15) at the end of its life.

This invention relates to glazing panels and particularly but not exclusively to an arrangement which facilitates removal of a glazing panel from a frame at the end of the glazing panel's life.

Whilst the invention will be described with particular reference to laminated windscreens it may also be used in other applications, for example monolithic glazings, other laminated glazings, vehicle glazing, automotive glazing and architectural glazing.

A common way of assembling a windscreen in a car comprises using an extruded strip or bead of adhesive, for example a polyurethane adhesive, spaced from the periphery of the glazing to adhere one face of the windscreen in a frame which forms part of the vehicle's bodywork. The adhesive may contact a decorative enamel band printed onto a surface of the windscreen rather than being in direct contact with the glass; this band hides the fixation from view from the exterior of the vehicle and may also protect the adhesive from incident ultra violet radiation. A primer may be used to facilitate adhesion between the adhesive and the glazing or enamel band.

Such adhesive systems facilitate assembly of a glazing in a vehicle frame and provide useful mechanical properties. However, they are less than ideal when it comes to remove a glazing from the vehicle, for example to replace a damaged glazing or at the end of the vehicle's life. It may also be difficult to remove the adhesive from the surface of the glazing, for example to facilitate recycling of the glazing. Theses disadvantages are inherent as the adhesive is selected to have sufficient adhesion both to the vehicle frame and to the glazing to avoid undesired separation during the life of the vehicle. Often the adhesive is also chosen to have sufficient mechanical resistance to enable the glazing to contribute to the rigidity of the vehicle.

Separation of the glazing from the bodywork by cutting the adhesive, for example using a knife, is difficult and time consuming; the inaccessibility of the adhesive when the glazing is in place also makes this inconvenient. Even when accomplished it may still be necessary to remove the adhesive from the surface of the glazing if the glazing is to be recycled. Alternatively, a central portion of the glazing may be cut out and separated leaving a peripheral band of glazing still adhered to the bodywork via the adhesive. This is again time consuming and requires special tools and precautions.

According to a first aspect, the present invention provides a glazing panel as defined in claim 1.

The glazing panel may comprise a single, monolithic sheet of glass. Alternatively, the glazing panel may comprise a single sheet of glass laminated to a plastics layer, for example a layer of substantially transparent polyurethane (PU) or polycarbonate. In this case, the glass sheet is preferably secured to the fixing element, for example by arranging the glass sheet as the inner sheet of the glazing or, when the glass is the outer sheet of the glazing arranging for the laminating layer not to extend to the periphery of the glazing panel so that a peripheral attachment portion of the glazing panel comprises the glass sheet secured to the fixing member without direct fixing of the laminating layer to the fixing member.

The heatable fracturing element may be adapted to:
a) fracture a portion of the, one or each sheet of glass of the glazing panel; and/or
b) fracture at least a portion of the laminating layer, particularly, to substantially destroy the integrity of a portion of the laminating layer.

In the former case, breaking or freeing of the laminating layer may be achieved, completed or suplemented by, for example cutting or tearing. In the latter case, fracturing of the glass may be achieved, completed or suplemented by physical contact, for example by tapping the glazing panel with a hammer.

According to a second aspects, the present invention provides a laminated glazing panel as defined in claim 2.

In the case of a laminated glazing panel, the glazing panel may comprise two sheets of glass adhered together by a laminating layer. Such a laminating layer may be a sheet of polyvinalbutyral (PVB); it may have a thickness of between about 0.2 mm and 1.2 mm. Standard PVB thicknesses for car windscreens are 0.38 mm and 0.76 mm. The laminating layer may be a composite layer; it may comprises, for example, two sheets of PVB having another layer, for example a sheet of polyethylene terephtalate (PET) sandwiched between them. Such a PET (or other sheet) may carry a solar control coating, for example a magnetron sputtered coating stack-adapted to enhance the solar control properties of the glazing.

The or each sheet of glass may have a thickness of between about 1 mm and 8 mm, particularly between about 1.5 mm and 3.5 mm, more particularly between about 1.8 mm and 2.5 mm.

The fixing member may be a bead of adhesive, for example, a polyurethane (PU) adapted to glue the glazing panel in its frame. Alternatively, the fixing member may be an element secured at or to a surface of at least one of the sheets of glass of the glazing panel, for example by an adhesive, which is adapted to form part of a fixation to secure the glazing panel in a frame. The fixing member may be adapted to be secured directly to a surface of the glass of the glazing panel; alternatively, it may be adapted to be fixed to layer carried on a surface of the glass of the glazing panel, for example an opaque enamel mask, or it may be adapted to be fixed to a profile or sealing joint secured to a surface of the glass of the glazing panel which may form part of the fixing member. A surface treatment, for example using a primer, may be used to help secure the fixing member to the glazing panel.

The attachment portion may comprise a peripheral portion of the glazing panel which extends to a peripheral edge of the glazing panel. Alternatively, the attachment portion may comprise a portion of the glazing panel spaced from the peripheral edge, for example spaced by a distance of between about 5 mm and 50 mm from the edge of the glazing panel. The attachment portion may follow the entire periphery of the glazing panel or may follow part of the periphery of the glazing panel, for example, along part of an edge of the glazing panel. The attachment portion may be between about 5 mm and 50 mm wide.

The heatable fracturing element may be a wire or conductive line, for example an electrically conducting enamel printed on the glazing; it may be adapted to be heated by connection to an electrical power source or by induction or by excitation (for example by a laser or by infrared or microwave energy). In the case of a laminated glazing having two glass sheets, the heating element may be provided between the two sheets of glass and/or at the upper and/or lower surfaces of one or both of the sheets of glass and/or on or within the laminating layer (for example by a wire). The heatable fracturing element may be provided by a portion of a coating which forms part of the glazing panel, for example an electrically conductive solar control coating; in this case, the desired form or pattern of the heatable fracturing element may be obtained by masking the glazing panel prior to deposition of the coating layer . Where the glazing panel has a masking band, for example of a black enamel, this may be used to mask the presence of the heatable fracturing element.

Arranging the heatable fracturing element as a series or array of individual heating elements, particularly induction elements, may help to ensure that if one fracturing element is broken, for example, during breakage of the glazing, or is damaged, other heating elements remain intact to perform their function. The heatable fracturing element or portions thereof may be damaged or destroyed during the heating process and/or during removal of the glazing panel. Printing the heatable fracturing element on a surface of the glazing panel, particularly silk screen printing, may be convenient. A silver containing enamel or silver paste similar to that commonly use for heating networks on rear windows of cars may be used.

In the case of a laminated glazing, separate heatable fracturing elements may be provided at each glass sheet. This may facilitate fracturing of both sheets when this is desired and/or facilitate destruction of the integrity of the laminating layer between the heatable fracturing elements. Alternatively, a heatable fracturing element may be adapted to cause fracturing of one or both of the glass sheets of a two sheet laminated glazing panel.

A portion of the glazing panel which is adapted to be separated from the fixing member by means of the heatable fracturing element may be annealed or hardened or even tempered. Arranging this portion to have a surface compression of less than about 70 Mpa, perhaps less than about 25 MPa may help to localise the fracturing of the glazing panel caused by the heatable fracturing element and avoid the entire glazing panel fragmenting into small pieces, as may be the risk with an entirely tempered glazing panel.

The heatable fracturing element may be a metallic or metal containing element; it may be a wire, for example an electrically conductive wire, or other resistive element adapted to be connected directly to a source of electrical power. Alternatively, where the heatable fracturing element is adapted to be heated by induction the need for direct electrical connection may be avoided. This may also enable the heatable fracturing element to be entirely embedded within the glazing structure, particularly in the case of a laminated glazing, and thus avoid the risk of ingress of humidity by means of any part of the heatable fracturing element protruding from the glazing panel. The heatable fracturing element may be heatable electromagnetically.

For laminated glazings, adapting the heatable fracturing element to substantially destroy the integrity of the laminating layer at a portion of the glazing panel may greatly facilitate separation of at least a portion of the glazing from its fixing member. Even partially destroying the integrity of the laminating layer may be useful if this allows the glazing panel to be pulled free or if it facilitates cutting or destruction of any portion of the laminating layer which would otherwise prevent removal of the glazing panel from its frame. It is generally only necessary to destroy the integrity of the laminating layer at one portion of the attachment portion, for example by melting or burning the laminating layer at this point.

According to further aspects, the present invention provides a glazing panel as defined in claim 13, a vehicle comprising a glazing panel as defined in claim 14, for use of a glazing panel as defined in claim 15 and for methods of removing a glazing panel as defined in claims 16 and 17.

Where the heatable fracturing element is heated by induction, an induction inducing element in the form of a copper tube may be used. A power of between about 500 watts and 10 kilowatts at a frequency of between about 500 and 1200 KHz may be supplied to the induction inducing element which may be positioned between about 1 mm and 40 mm from the heatable fracturing element, preferably less than about 25 mm or 15 mm from the heatable fracturing element. The breakage characteristics of the heatable fracturing element may be modified by the form, composition and resistivity of the heatable fracturing element and by the form, power, frequency and position of the induction inducing element. The heatable fracturing element may comprise a magnetic material, for example an iron containing material; this may facilitate heating by induction.

Embodiments of the invention will now be described, by way of example only, with reference to the accompanying drawings of which:

FIG. 1 is a plan view of a laminated windscreen;

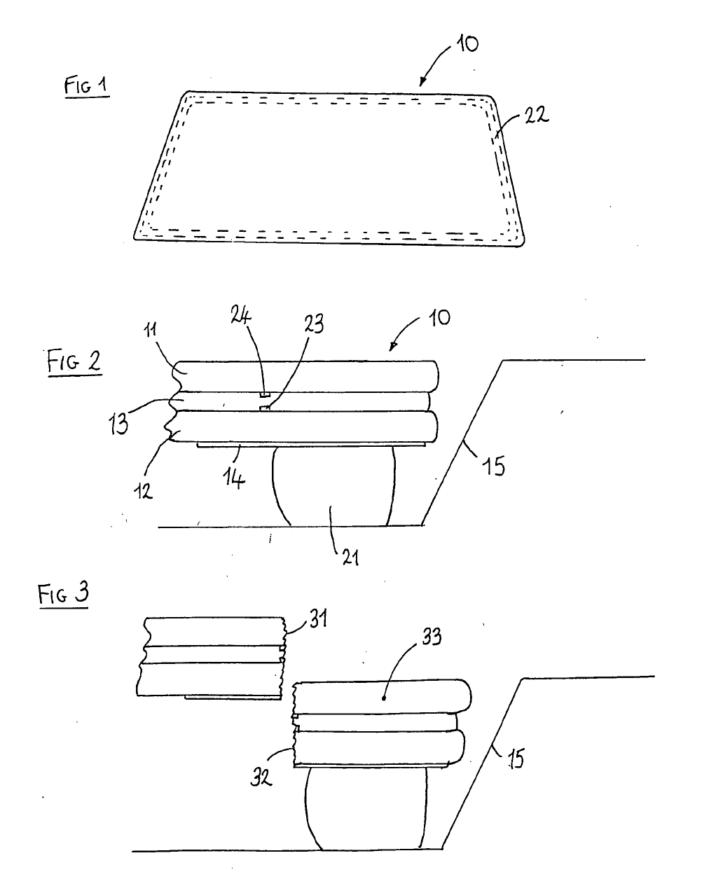

FIG. 2 is a sectional view through a peripheral portion of the windscreen of FIG. 1 assembled in a frame;

FIG. 3 is a sectional view equivalent to FIG. 2 showing removal of the windscreen from its frame;

FIG. 4 is a plan view of an alternative form of a laminated windscreen;

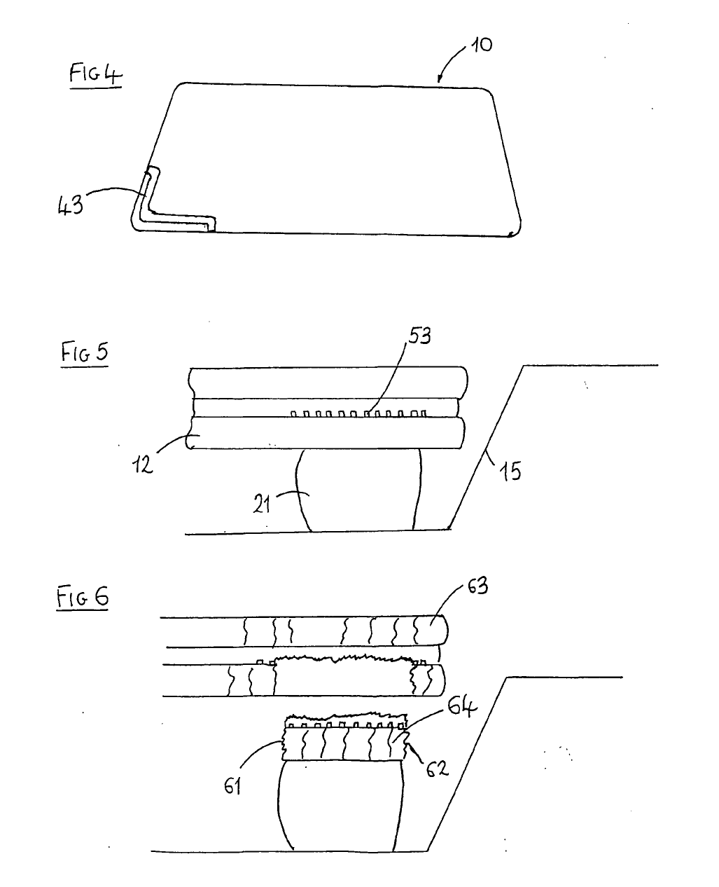

FIG. 5 is a sectional view of the peripheral portion of an alternative laminated windscreen assembled in a frame;

FIG. 6 is a sectional view equivalent to FIG. 5 showing removal of the windscreen from its frame;

FIG. 7 is a sectional view of the peripheral portion of another windscreen assembled in a frame;

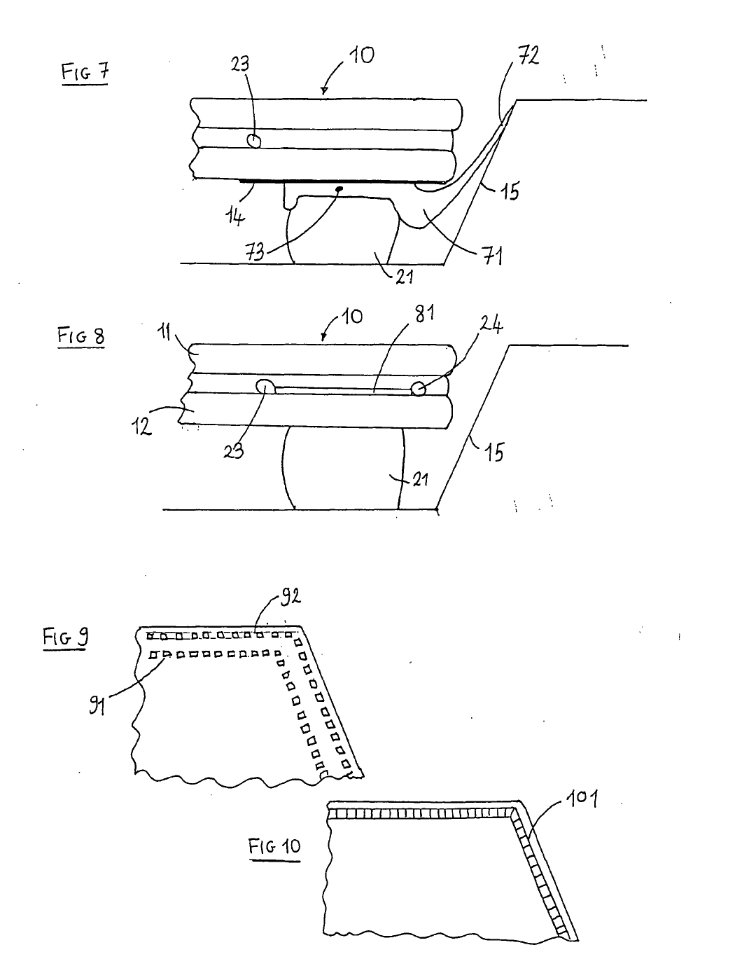

FIG. 8 is a sectional view of the peripheral portion of a further windscreen assembled in a frame;

FIG. 9 is a plan view of a corner section of a glazing panel; and

FIG. 10 is a plan view of a corner section of an alternative glazing panel.

The windscreen 10 of FIG. 1 is adapted to be secured into a frame 15 provided as part of a car's bodywork be means of a fixing member in the form of a bead of adhesive 21. The bead of adhesive 21 is adapted to contact the windscreen around its entire periphery at an attachment portion 22; the attachment portion 22 is in the form of a band having a width of between about 25 mm and 40 mm spaced by a distance of between about 5 mm and 25 mm from the peripheral edge of the windscreen. The bead of adhesive 21 is secured at the attachment portion of the glazing panel over a width of about 5 to 15 mm.

As shown in FIG. 2, the windscreen comprises two sheets of glass 11, 12 adhered together by a sheet of PVB 13. A masking band of black enamel 14 (not shown in FIG. 1) is provided on the underside of the windscreen to mask the adhesive 21 from the exterior of the vehicle.

Electrically heatable fracturing elements 23,24 are provided around the entire attachment portion 22 in the form of induction heatable electrical circuits printed respectively on the external sheet of glass 11 and on the internal sheet of glass 12 at which the fixing element 21 is secured. Positioning of the heatable fracturing elements 23,24 between the two sheets of glass protects them from damage during manipulation and use of the windscreen.

To remove the windscreen 10 from its frame 15 the heatable fracturing elements 23,24 are heated by induction. A copper inductor may be moved progressively around the periphery of the windscreen at the surface of the glazing or at a distance of about 5 to 50 mm from the glazing to cause induction currents in the heatable fracturing elements 23,24. Alternatively, an inductor having the form of at least part of the periphery of the glazing panel or at least of part of the form followed by the heatable fracturing elements 23,24 around the periphery of the windscreen may be positioned at the windscreen to cause induction currents to flow in the heatable fracturing elements 23,24. The stresses that the heating of the heatable fracturing elements 23,24 cause in the glass sheets 11,12 of the glazing panel cause these sheets to fracture at the attachment portion. The heat also destroys the integrity of the PVB laminating layer at the attachment portion. Once fractures 31, 32 have been created in the glass sheet 12 at positions spaced inwardly from the adhesive band 21, a central portion of the windscreen 10 can be lifted clear of the frame 15 leaving a peripheral band 33 of the windscreen still attached to the frame 15 via the adhesive bead 21. Whilst the glass of peripheral band 33 may be fractured by this process it remains, at least for the most part, adhered to the adhesive bead 21 either directly or via the remaining PVB laminating layer. If the integrity of the PVB laminating layer is not entirely destroyed by the heating of the heatable fracturing elements 23,24, the PVB may be cut with a blade from the outside of the glazing panel to enable the central portion of the glazing panel to be lifted clear from the frame 15.

Once the windscreen 10 is removed, easy access is provided to the adhesive bead 21; this may be useful to enable total or partial removal of the adhesive bead 21 from the frame 15 for example to fit a replacement windscreen in the frame.

The substantial absence of adhesive 21 from the portion of the windscreen that is removed may facilitate recycling of the glazing. If the decorative enamel band 14 (if used) is not itself recyclable it may be arranged such that the portion of the glazing removed is also substantially free of this decorative enamel. Whilst some glass 33 remains attached to the adhesive 21, the vast majority of the weight of the windscreen is recuperated; this may be advantageous for recycling purposes.

FIG. 4 shows an alternative embodiment in which an heatable fracturing element 43 (provided in a fashion similar to that of FIG. 1) is provided at only one portion of the periphery of the windscreen 10. This portion may be separated as described above and used to provide an access to facilitate separation of the remaining portions of the windscreen, for example, by providing an access for a crowbar or other lever to be inserted between the windscreen and the frame. In such an arrangement part or all of the heatable fracturing element 43 may be hidden or protected in normal use of the vehicle, for example, by being positioned at a portion of the windscreen protected or covered by the vehicle bonnet in normal driving use.

The attachment portion and/or the heatable fracturing element may be discontinuous and more than one attachment portion and/or heatable fracturing element may be used.

In the embodiment of FIG. 5 and FIG. 6, the heatable fracturing element is provided by a network of induction circuits provided at the surface of the glass sheet 12 to which the fixing element 21 in the form of a bead of adhesive is attached and 20 extending substantially across the entire width at which the adhesive bead 21 is secured to the glazing panel.

As shown in FIG. 6, when the heatable fracturing element 53 is heated, fractures 61,62 are created in the lower glass sheet 12 inwardly and outwardly of the adhesive bead 21 and the integrity of the PVB laminating layer is destroyed at the position at which the adhesive bead is secured to the glazing panel. A central portion 63 of the windscreen may be removed whilst a peripheral portion 64 remains attached to the adhesive band 21.

The embodiment of FIG. 7 has a fixing member 71 in the form of a moulded or extruded profile having a sealing lip 72 and a base 73 which is firmly secured to a black enamel band 14 at the underside of the windscreen 10. The profile 71 is adhered in the vehicle frame 15 by an adhesive bead 21. In this embodiment, the profile 71 remains attached to the vehicle bodywork 15 when a central portion of the glazing is removed as in FIG. 3. This may facilitate recycling of the glazing. In this embodiment, the heatable fracturing element takes the form of a copper wire 21 running around the periphery of the glazing and having a connection portion protruding from the glazing for connecting the wire to an electrical power source. A plurality of substantially parallel, or indeed overlapping wires may be used. The diameter of the wire is chosen to enable its positioning between the two sheets of glass and to facilitate both breaking both sheets of glass and destroying the integrity of the PVB between the two sheets of glass between the wire.

In the embodiment of FIG. 8, a weakness zone is provided between spaced heatable fracturing elements 23,24 by means of a zone of substantial non-adherence between the PVB laminating layer and the glass sheet 12 at the portion of the glass sheet 12 at which the fixing element 21 is secured. This removes the need for the heatable fracturing elements 23,24 to destroy the integrity of the PVB laminating layer as once the lower sheet of glass 12 has been fractured inwardly and outwardly of the adhesive bead 21, a central portion of the glazing may be removed as in FIG. 6.

FIG. 9 and FIG. 10 show forms of heating elements 91, 92, 101 particularly adapted for printing onto a surface of a glass sheet in an electrically conductive enamel (for example a silver paste typically used for the heating network printed on to the rear window of a car to provide a de-misting resistance heater) and subsequent heating by induction to cause localised breakage of the windscreen. The plurality of closed circuits provided by the patterns ensures that if one or more of the closed circuits breaks, either before or during localised breakage of the windscreen, the closed circuits which remain in tact remain heatable by induction. The line or lines of a heatable fracturing element adapted to be heated by induction may have a width of between about 0.2 and 5 mm, preferably between about 0.5 and 2 mm and a thickness of between about 3 to 10 microns, preferably about 5 microns. They may have a resistivity of between about 1 and 15 microohm cm, preferably between about 3 and 10 microohm cm.

Preferably, glazings according to the invention conform to European standard R43.

The ability to quickly remove the glazing from its frame may be used to minimise the time needed to dismantle the vehicle or replace the glazing or to provide access through the glazing in the case of an accident.

1. A glazing panel having an attachment portion at which the glazing panel is adapted to be secured to a frame by a fixing member secured at a surface of the glazing panel characterised in that at least part of the attachment portion comprises a heatable fracturing element adapted to fracture at least a portion of the glazing panel to facilitate separation of at least a portion of the glazing from its fixing member.

2. A laminated glazing panel comprising at least two sheets of glass adhered together by a substantially transparent laminating layer, the glazing panel having an attachment portion at which the glazing panel is adapted to be secured to a frame by a fixing member secured at a surface of at least one of the sheets of glass characterised in that at least part of the attachment portion comprises a heatable fracturing element adapted to fracture at least a portion of the glazing panel to facilitate separation of at least a portion of the glazing panel from its fixing member.

3. A glazing panel in accordance with claim 1 or claim 2, in which the heatable fracturing element comprises an electrical resistance adapted to be heated by connection to an electrical power source.

4. A glazing panel in accordance with any preceding claim, in which the heatable fracturing element is adapted to be heated by induction.

5. A laminated glazing panel in accordance with any preceding claim, in which the heatable fracturing element is adapted to fracture at least a portion of the glass of the glazing panel and is adapted to substantially destroy the integrity of the laminating layer at a portion of the glazing panel so as to facilitate separation of at least a portion of the glazing panel from its fixing member.

6. A glazing panel in accordance with any preceding claim, in which the heatable fracturing element is provided by a network of electrically conducting lines provided as part of the glazing panel.

7. A glazing panel in accordance with claim 6, in which the heatable fracturing element is provided by a network of electrically conducting lines comprising an electrically conductive enamel material printed at a portion of the glazing panel.

8. A laminated glazing panel in accordance with any preceding claim, in which the heatable fracturing element is provided between two sheets of glass of the laminated glazing panel.

9. A laminated glazing panel in accordance with any preceding claim, in which the laminating glazing panel comprises at least two sheets of glass and in which a heatable fracturing element is associated with each of the sheets of glass of the laminated glazing panel.

10. A laminated glazing panel in accordance with any preceding claim, in which the heatable fracturing element extends across substantially the entire width at which the fixing element is adapted to be secured at the glazing panel.

11. A laminated glazing panel in accordance with any preceding claim, in which the heatable fracturing element comprises a plurality of closed induction circuits.

12. A laminated glazing panel in accordance with any preceding claim, in which the glazing panel is provided with a weakness zone at the attachment portion between the two sheets of glass of the laminated glazing, the weakness zone providing a discontinuity in the adhesion between the laminating layer and a sheet of glass of the glazing panel which is adapted to be secured to the fixing member so as to facilitate separation of at least a portion of the glazing panel from a frame in which it is secured.

13. A glazing panel assembled in a frame provided as part of an automotive vehicle in which the glazing panel comprises an attachment portion at which the glazing panel is adapted to be secured to a frame by a fixing member secured at a surface of the glazing panel characterised in that at least part of the attachment portion comprises a heatable fracturing element adapted to fracture at least a portion of the glazing panel to facilitate separation of at least a portion of the glazing from its fixing member.

14. A vehicle comprising a glazing panel in accordance with any preceding claim assembled in a frame of the vehicle characterised in that the fixing member secured at a surface of the glazing panel at its attachment portion comprises an adhesive attached directly to the vehicle's bodywork.

15. Use of glazing panel in accordance with any one of claims 1 to 13 to facilitate removal of at least a major portion of the glazing panel from a frame in which it is secured.

16. A method of removing at least a portion of a glazing panel in accordance with any one of claim 1 to 13 from a frame in which it is secured comprising the sequential steps of
a) causing heating of the heatable fracturing element to provoke at least partial breakage of the glazing panel at at least a section of the attachment is portion; and
b) using the thus broken section of the attachment portion to provide an access to facilitate removal of at least a portion of a glazing panel from the frame.

17. A method of removing at least a portion of a glazing panel in accordance with any one of claim 1 to 13 from a frame in which it is secured in which the attachment portion follows substantially the entire periphery of the glazing panel and in which the heatable fracturing element is present around substantially the entire length of the attachment portion comprising the sequential steps of
a) breaking the glazing panel along substantially the entire length of the attachment portion by heating the heatable fracturing element; and
b) subsequently removing at least a portion of the glazing panel from the frame so as to leave at least some fragments of broken glass from the attachment portion secured to the frame.
